(19) United States
(12) Patent Application Publication
(10) Pub. No.: US 2008/0192024 A1
(43) Pub. Date: Aug. 14, 2008

(54) Operator distinguishing device

(76) Inventor: Chikara Mita, Nakano-ku (JP)

Correspondence Address: WENDEROTH, LIND & PONACK, L.L.P., 2033 K STREET N. W., SUITE 800, WASHINGTON, DC, 20006-1021, US

(21) Appl. No.: 12/068,870

(22) Filed: Feb. 12, 2008

(30) Foreign Application Priority Data
Feb. 14, 2007 (JP) 2007-032805

(51) Int. Cl. G06F 3/041

(52) U.S. Cl. 345/173

(57) ABSTRACT

An operator distinguishing device has a display part, an operation part provided in a touch panel arranged in front of the display part, and a control part. The touch panel has a plurality of electrodes for generating electrostatic capacity change when a hand of one of the operators approaches the touch panel, and the touch panel is arranged at a position where the touch-panel side hands of the operators need to approach to the touch panel from lateral side edge portions, which are at operator-to-operate sides, of the touch panel, respectively. The control part detects the electrostatic capacity change level generated by an approaching hand of the operator to distinguish the operator, who approaches the hand to the touch panel, from the other operator before the hand touches the touch panel.

### BACKGROUND OF THE INVENTION

1. Field of the Invention

The present invention relates to an operator distinguishing device that is capable of distinguishing between two operators who can perform an input operation of an on-vehicle device from two opposite sides of the equipment. The invention also relates to a method for distinguishing between operators likewise.

2. Description of the Related Art

An operator distinguishing device of this kind is disclosed in Japanese patent application laid-open publication No. 2006-72854. This operator distinguishing device has a touch pad which a user operates, a display for providing an image including Graphical Use Interface (GUI) components for the user, and an operation part for arithmetically and logically calculating data outputted from the touch pad to produce image signals according to an input into the touch pad and sending them to the display.

The touch pad has a detecting element consisting of a plurality of electrostatic capacity sensors or pressure sensors. With these sensors, the touch pad can simultaneously detect a plurality of positions thereof which are pressed by fingers and a palm of the user, or which the fingers and the palm approach. This input into the touch pad provides the image on the display with an image, including five fingers and palm, of a user's hand, so that the user can easily operates the GUI components, watching the image of the user's hand movable according to his or her real hand movement.

The touch pad is separated from the touch screen and is installed on extension of a center console and at a location in which the user can operate it with resting the user's elbow on an elbow rest, or on an armrest in the center of a backseat for backseat passengers to operate it. This arrangement of the touch pad enables the users to comfortably operate it, while it results in the hand of the user approaching or putting on the touch pad from a substantially rear side of the touch pad toward a substantially front side thereof. It is, therefore, difficult to judge whether user's hand approaches from a left side of the touch pad or from a right side thereof.

In order to overcome the above-described problem, the operation part of the above-conventional device is designed to judge, based on the contact location data outputted from the detecting element and by using a calibration processing or various algorithms, whether a right hand or a left hand is put on an actuation side of the detecting element, and then determines based on the judgment result which of the users, namely a driver or a front seat passenger, tries to operate the touch pad. As a result, this right-hand and left-hand judging process is complicated, and it requires a high computing capacity and high manufacturing costs.

On the other hand, in order to easily detect and distinguish between the right hand and the left hand of the users approaching the touch pad, the above Japanese patent application also discloses a plurality of infrared ray sensors which are arranged at a plurality of positions encompassing an operating surface of the touch pad so as to detect the hand approaching or being over the touch pad. The usage of the infrared ray sensors, however, results in a complicated structure and accordingly it increases its manufacturing costs.

Incidentally, Japanese patent applications laid-open publication No. (Sho) 08-184449 and No. 2005-96655 disclose operator distinguishing devices with a plurality of infrared ray sensors arranged around a display which is not a touch panel screen and has no touch pad. These devices cannot avoid the similar problem.

It is, therefore, an object of the present invention to provide an operator distinguishing device which overcomes the foregoing drawbacks and can distinguish between operators, eliminating an additional unit such as infrared ray sensors, and thereby decrease manufacturing costs and complexity in a structure of the operator distinguishing device.

### SUMMARY OF THE INVENTION

According to a first aspect of the present invention, there is provided an operator distinguishing device which distinguishing between a first operator and a second operator, includes a display part for providing an image, an operation part provided in a touch panel arranged in front of the display part, and a control part. The touch panel has a plurality of electrodes for generating electrostatic capacity change when a hand of one of the first and second operators approaches the touch panel, and the touch panel is arranged at a position where the touch-panel side hands of the first and second operators need to approach to the touch panel from lateral side edge portions, which are at operator-to-operate sides, of the touch panel, respectively. The control part detects the electrostatic capacity change level generated by an approaching hand of the operator to distinguish the operator, who approaches the hand to the touch panel, from the other operator before the hand touches the touch panel.

### BRIEF DESCRIPTION OF THE DRAWINGS

The objects, features and advantages of the present invention will become apparent as the description proceeds when taken in conjunction with the accompanying drawings, in which:

FIG. 1 is a control block diagram of an operator distinguishing device of a first embodiment according to the present invention;

FIG. 2 is a view showing a capacitive touch screen used in the operator distinguishing device of the first embodiment shown in FIG. 1;

FIG. 3 is a diagram showing a relationship between a lateral position and a detected electrostatic capacity generated in electrodes of the touch screen when a finger of an operator comes close to the touch screen;

FIG. 4 is a schematic plan view showing an installation position of the touch screen relative to the operators;

FIG. 5A is a front view of a touch panel screen which the finger approaches, FIG. 5B is a diagram showing a relationship between a lateral position of the touch screen and a detected electrostatic capacity when a finger of a front seat passenger as the operator approaches a touch panel screen from a left side thereof, and FIG. 5C is a diagram showing a relationship between the lateral direction of the touch panel and a detected electrostatic capacity when a finger of a driver as the operator approaches the touch panel screen from a right side thereof;

FIG. 6 is a front view showing an image produced on the touch panel screen when their fingers do not approach the touch panel screen;

FIG. 7 is a front view showing an example of an image on the touch panel screen in which GUI icon images thereon are set to be displayed at an undesirable position when the hand of the front seat passenger approaches the touch panel screen;

FIG. 8 is a front view showing an image on the touch panel screen in which the GUI icon images are set to be displayed at a desirable position when the hand of the front seat passenger approaches the touch panel screen;

FIG. 9 is a front view showing an image on the touch panel screen in which the GUI icon images are not displayed in order to secure the passengers' safety when the hand of the driver approaches the touch panel screen in execution of a navigation system during running;

FIG. 10 is a front view showing an image on the touch panel screen in which various GUI icon images are set to be displayed at a left side thereof so that only the front seat passenger can operate them during running;

FIG. 11 is a front view showing an example of a navigation device with a menu button provided at an exterior of an image on its touch panel screen in which none of the GUI icon images are set to be displayed as long as the finger of the operator does not press the menu button;

FIG. 12 is a front view showing an image on the touch panel screen in which none of the GUI icon images are set to be displayed when no hand of the operators does not touch or press the touch panel;

FIG. 13 is a front view showing an image on the touch panel screen in which none of the GUI icon images are displayed when the hand of the front seat passenger begins to approach the touch panel;

FIG. 14 is a front view showing an image on the touch panel which is shifted so that the GUI icon images are displayed at the left side thereof when the hand of the front seat passenger is detected to approach the touch panel;

FIG. 15 is a front view showing an image on the touch panel screen which is shifted so that the GUI icon images are displayed at the right side thereof when the hand of the driver is detected to approach the touch panel during vehicle stop;

FIG. 16 is a front view showing the image in which the GUI icon images are not displayed when the hands of the operators do not approach or press the touch panel;

FIG. 17 is a flow chart illustrating an input process and an operator distinguishing process executed by the operator distinguishing device of the first embodiment;

FIG. 18 is a front view showing a touch panel of an operator distinguishing device of a second embodiment according to the present invention;

FIG. 19 is a perspective view showing the touch panel which illustrates how detected electrostatic capacity changes by location according to an approaching movement of a hand of an operator;

FIG. 20 is a front view showing the touch panel with non-adjustable detection sensitivity levels for sensing the hand of the operator: and

FIG. 21 is a front view showing the touch panel with adjustable detection sensitivity levels for sensing the hand.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

A first preferred embodiment of an operator distinguishing device according to the present invention will be described with reference to the accompanying drawings.

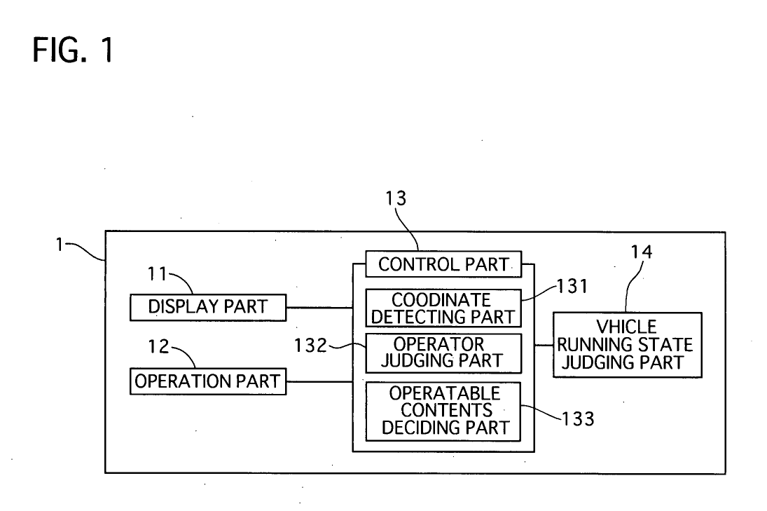

Referring to FIGS. 1 to 4 of the drawings, there is shown the operator distinguishing device 1 of the first embodiment.

As shown in FIG. 1, the operator distinguishing device 1 includes a display part 11 for providing an image, an operation part 12 for an input operation, a control part 13 for executing arithmetic and logic process, and a vehicle running state judgment part 14.

The display part 11 has a Liquid Crystal Display (LCD) for providing an image including information, GUI icons and others. The display part 11 is electrically connected to the control part 13.

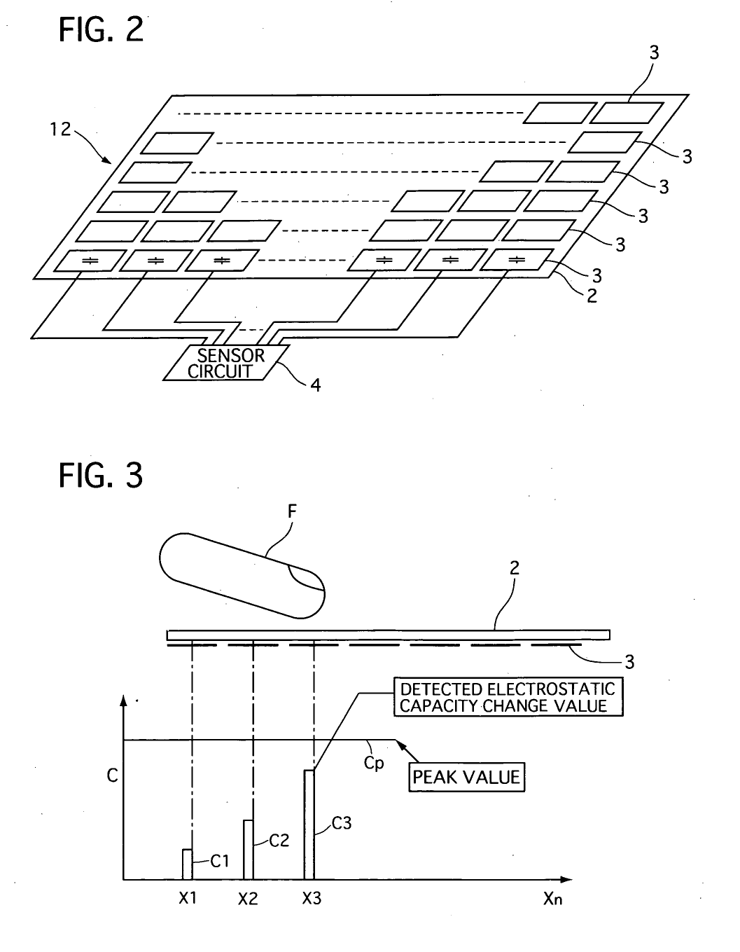

The operation part 12 has an electrostatic capacitive touch panel 2 shown in FIGS. 2 and 3, which includes and a transparent touch panel screen, with double side transparent conductive coating typically made of indium tin oxide, at a front side of the LCD. The operation part 12 is provided as the GUI icons such as a button image in an image displayed on the touch panel 2, where the touch panel 2 has a plurality of portions, on which a bare finger of an operator can press to input, where an image on the display part 11 is superimposed. The portions are provided with a plurality of electrodes 3 which are allocated in a matrix arrangement as shown in FIG. 2. The electrodes 3 are electrically connected to a sensor circuit 4 so that they can detect a position pressed by the operator. The operation part 12 is electrically connected to the control part 13.

The control part 13 judges what is an input operation and distinguishes between the two operators, and it includes a coordinate detecting part 131, an operator judging part 132 and an operatable contents deciding part 133.

The coordinate detecting part 131 is electrically connected to the operation part 12, and determines the coordinates of an inputted position by processing signals outputted from the operation part 12, specifically from the sensor circuit 4 connected to the electrodes 3 when an input operation is performed in the operation part 12.

The operator judging part 132 is electrically connected to the coordinate detecting part 131, and distinguishes between the operators, namely a driver and a front seat passenger, by processing signals outputted from the operation part 12. One of the driver and the front seat passenger corresponds to a first operator of the present invention, and the other thereof corresponds to a second operator.

The operatable contents deciding part 133 is electrically connected to the coordinate detecting part 131, the operator judging part 132 and the vehicle running state judging part 14, and decides contents to be operatable by the operator, based on a detected result of the coordinate detecting part 131, a judgment result of the operator judging part 132 and a judgment result of the vehicle running state judging part 14. The operatable contents are shifted to differ from each other according to the results. In addition, the operatable contents deciding part 133 is electrically connected to the display part 11.

The vehicle running state judging part 14 judges whether a motor vehicle that the operators ride is running or stops, based on a signal outputted from an on-vehicle devices such as a speed sensor or an inhibitor of an automatic transmission.

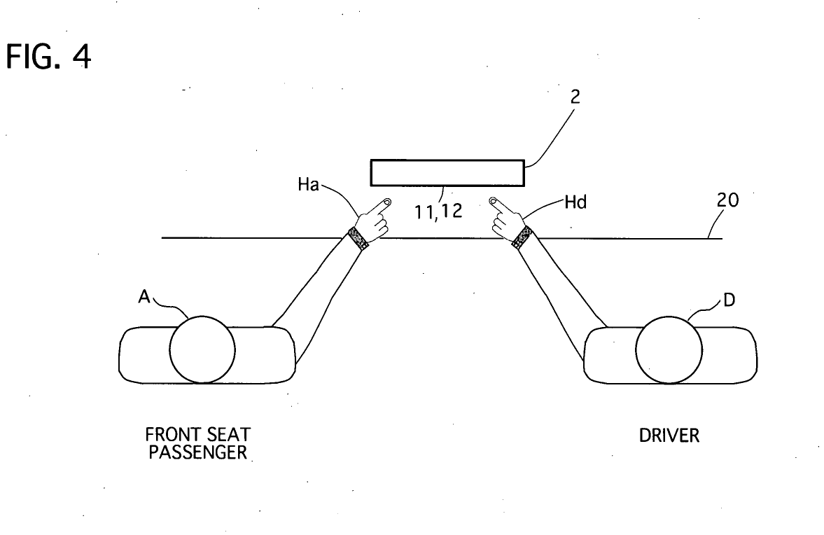

As shown in FIG. 4, the touch panel 2 is installed on an intermediate portion of an instrument panel 20. Specifically, the operation part 12 of the touch panel 2 is disposed in front of the driver D and the front seat passenger A and also therebetween. In addition, the operation part 12 is arranged at a position where, in order to operate the operation part 12, a left hand (a touch-panel side hand) Hd of the driver D needs to approach it from a right side portion of the touch panel 2 and a right hand (a touch-panel side hand) Ha of the front seat passenger A needs to approach it from a left side portion of the touch panel 2 in a motor vehicle with a right hand steering wheel. Incidentally, in a motor vehicle with a left hand steering wheel, the operation part 12 is arranged at a position where a right hand (a touch-panel side hand) of a driver needs to approach it from the left side portion of the touch panel 2 and a left hand (a touch-panel side hand) of a front seat passenger needs to approach it from the right side portion thereof.

The operation of the operator distinguishing device 1 of the first embodiment will be described.

Distinguishing between the operators and judging the input operation are executed based on a change of the electrostatic capacity of the electrodes 3 of the touch panel 2 which changes according to a position of a hand of the operator.

In this embodiment, the operator judging part 132 reads capacity signals outputted from the electrodes 3 to calculate change values of the electrostatic capacity generated according to a distance difference between the touch panel 2 and a finger (or a hand) of the operator. Then, it judges, based on the change values of the electrostatic capacity, which of the driver D and the front seat passenger A approaches his or her finger (or hand) to the touch panel 2. Note that the operator judging part 132 is capable of judging the operator based on the capacity change values, due to an approaching hand, generated before it touches the touch panel 2.

A principle of distinguishing the operators based on the electrostatic capacity change values will be described with reference to FIG. 3. When a finger F of the front seat passenger A approaches the touch panel 2 from the left side portion of the touch panel 2, the finger F normally keeps being slanted in a direction perpendicular to the touch panel screen so that its tip comes closer to a front surface of the touch panel 2 than its palm side portion. Consequently, since the electrodes 3 are provided on a whole area of a rear surface of the touch panel 2, the electrodes 3 which are near the finger F change their electrostatic capacity according to a distance between portions of the finger F and the electrodes 3. The electrode 3 located at the closest position X3 which corresponds to the tip portion of the finger F generates the largest capacity change value C3, the electrode 3 located at an intermediate position X2 which corresponds to an intermediate portion of the finger F generates an intermediate capacity change value C2, and the electrode 3 located at a left edge side position X1 which corresponds to the palm side portion of the finger F generates the smallest capacity change value C1. The rest of the electrodes 3 do not generate detectable capacity change values because the finger F is too far therefrom to detect the capacity change values. Incidentally, a peak level of the detectable capacity change value is indicated as a line Cp in FIG. 3.

Thus, the operator distinguishing device 1 can receive an electrostatic capacity change signals outputted from the electrodes 3 and judge based on the received signals which side of the electrodes generates the capacity change values C1 to C2. The device 1 distinguishes the operator who approaches his or her hand to the touch panel 2 from another operator, based on the judgment. In the above case, it judges the capacity change values to be generated at the left side of the touch panel 2, and accordingly it judges that the operator who intends to operate the touch panel is the front seat passenger A, not the driver D. On the other hand, when the device 1 judges the capacity change values to be at the right side portion of the electrodes 3, it judges that the operator who intends to operate the touch panel 2 is the driver D.

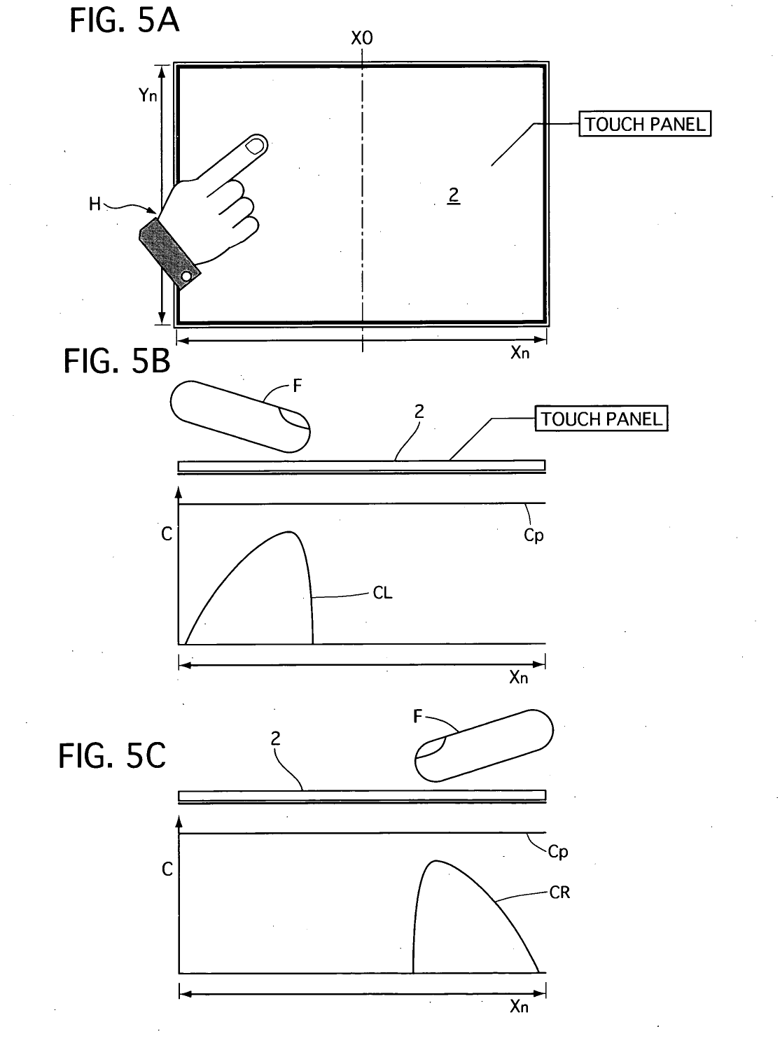

Specifically, as shown in FIG. 5A, a coordinate with lateral coordinates Xn—longitudinal coordinates Yn is set on the touch panel 2, where a center longitudinal line X0 is provided at the center of the touch panel 2. Therefore, the center longitudinal line X0 divides the left side portion and the right side portion of the touch panel 2 from each other with respect thereto. As a result, the electrodes 3 are also divided into a left side group and a right side by the center longitudinal line X0. Incidentally, the number of the electrodes 3 of the first embodiment is set larger than that shown in FIG. 3, which provides the capacity change values in a substantial waveform.

When the finger F of the hand H approaches the touch panel 2 from the left side thereof, the capacity change levels are detected as a first waveform CL at the left side portion of the touch panel 2 as shown in FIG. 5B. The first waveform progressively rises from the left side edge portion of the touch panel 2 toward its peak point, which corresponds to the tip portion of the finger F, and then rapidly drops. The operator distinguishing device 1 judges the operator who intends to operate the touch panel 2 to be the front seat passenger A when it recognizes a first waveform CL at the left side portion of the touch panel 2. On the other hand, the device 1 judges the operator who intends to operate the touch panel 2 to be the driver D when it recognizes a second waveform CR at the right side portion of the touch panel 2 as shown in FIG. 5C. The second waveform CR rapidly rises from a position in the right side portion of the touch panel 2 toward its peak point, and then gradually drops toward the right side edge portion thereof. The shapes of these waveforms CL and CR come from the fact that the fingers F are slanted relative to the front surface of the touch panel 2 when they approaches it and press the operation part 12.

These capacity change values generate when the finger F touches the touch panel 2 and before it touches the touch panel 2. This enables the operator distinguishing device 2 to distinguish between the operators at an earlier stage of an input operation movement of the operator. This enables the following process of the device 1 according to the input operation movement of the operator to be easily and smoothly performed. In addition, detection of the first and second waveforms CL and CR makes it possible for the device 1 to more accurately distinguish between the operators.

A detection sensitivity level of the electrodes 3 is set to be higher before the finger F touches the touch panel 2 than that set right before and when the finger F touches it. The higher detection sensitivity level of the electrodes 3 enables to easily and surely detect the approaching finger F, and the lower detection sensitivity level thereof enables to avoid wrong and ambiguous detection of a position of the electrodes pressed by the finger F when the finger F operates the operation part 12.

The input operation will be described with images displayed on the touch panel screen.

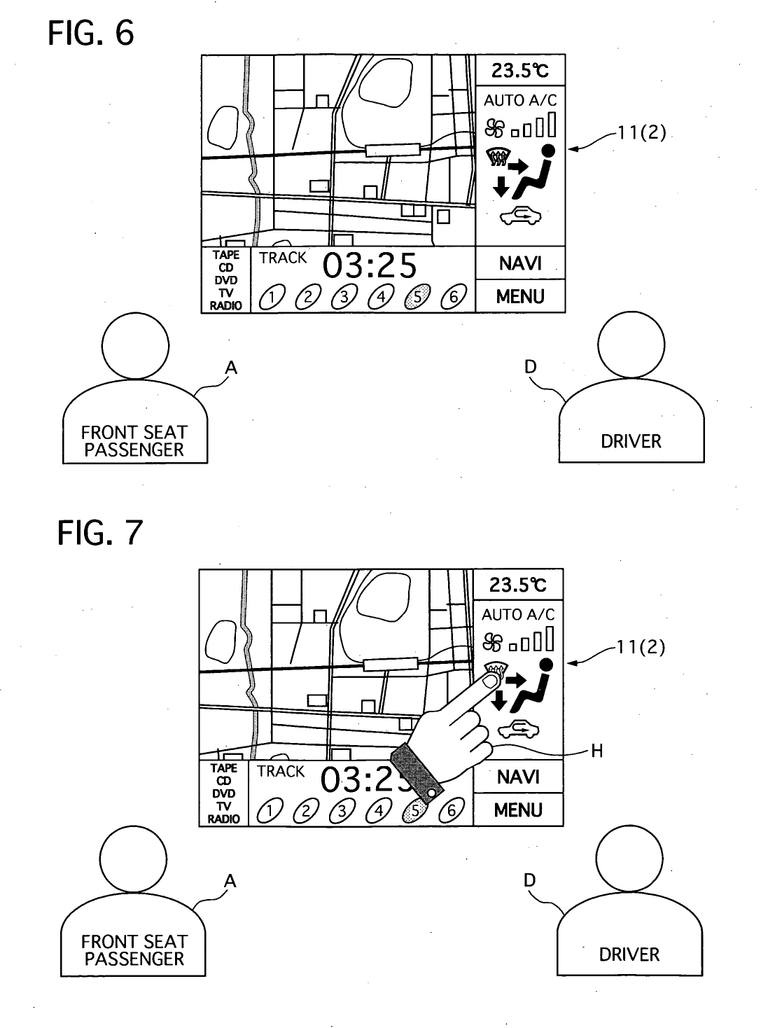

In the first embodiment, the operation part 12 is disposed in the touch panel screen as an icon image of the GUI, and it can be operated by the operator with respect to operations of an audio system, a navigation system, an air conditioner and others not-shown the on-vehicle devices. In other words, the image on the touch panel screen is capable of displaying contents image on information made by the selected on-vehicle device and an image of the GUIs at the same time. The operator can press the icon image displayed on the touch panel screen to continuously operate and set various functions of the on-vehicles, watching the image on the touch panel screen. Incidentally, in this case, the GUI icon images are arranged on a lower side portion and the right side edge portion of the touch panel screen and of the information image as shown in FIG. 6.

When the front seat passenger A-approaches his or her hand H to the touch panel 2 in order to operate the GUI icons of the air conditioner in the case shown in FIG. 6, it is inconvenient for the driver to watch information on the navigation, because the navigation information image is hidden by the hand H of the front seat passenger A as shown in FIG. 7.

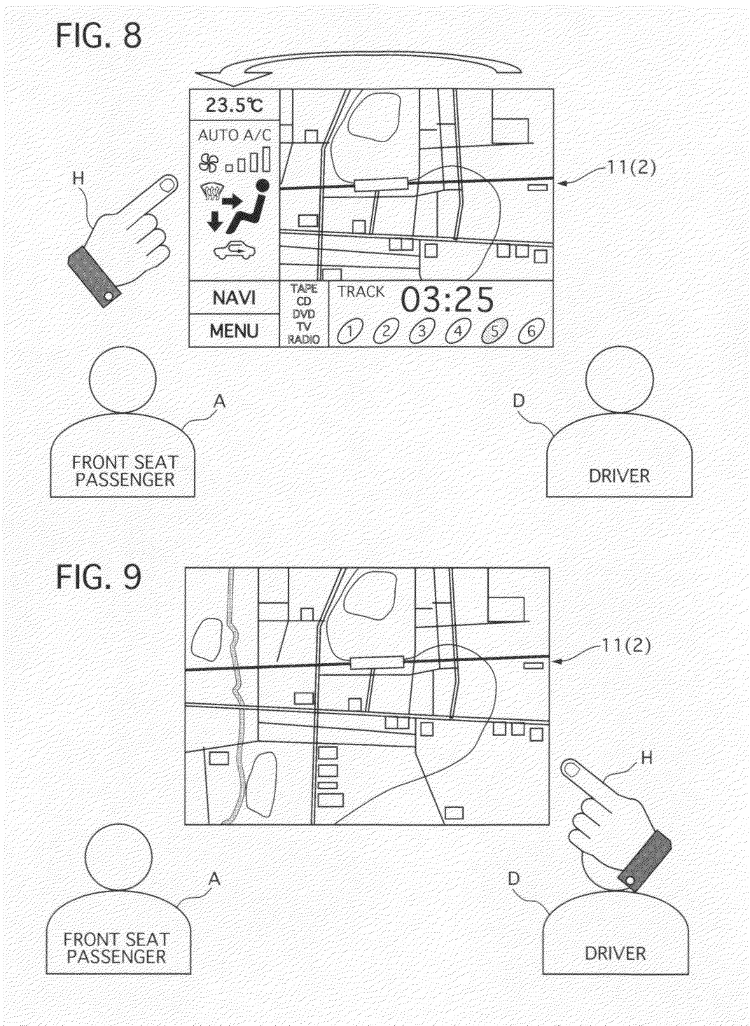

In order to avoid this advantage, the operator judging part 132 of the device 1 of the first embodiment judges the hand H of the front seat passenger A to be approaching from the left side portion of the touch panel 2, and the operatable contents deciding part 133 shifts the images displayed on the touch panel screen so that the GUI icon images of the air conditioner are moved to be arranged on the left side edge portion of the touch panel screen before the hand H touches the touch panel 2 as shown in FIG. 8. As a result, the navigation information image is prevented from being hidden by the hand, thereby the driver D being capable of watching it. In addition, the front seat passenger A can easily operate the GUI icons because they are moved nearer to the passenger A.

During driving, the displayed image excludes the GUI icon images as shown in FIG. 9 so that the driver D can devote himself to his or her driving operation for the sake of safety. The device 1 of the first embodiment is designed to allow only the front seat passenger A to operate the operation part 12 during driving. He or she can operate it on his or her will and according to oral instructions of the driver D for assisting him or her, thereby providing a comfortable driving.

On the other hand, in a case where the GUI icon images are not displayed on the touch panel screen during driving and a menu button 15 for displaying the GUI icon images is provided at an exterior of the touch panel screen or the touch panel 2 as shown in FIG. 11, it increases manufacturing costs of the device 1 and decreases design freedom of an interior of a passenger room and a display area of the touch panel screen.

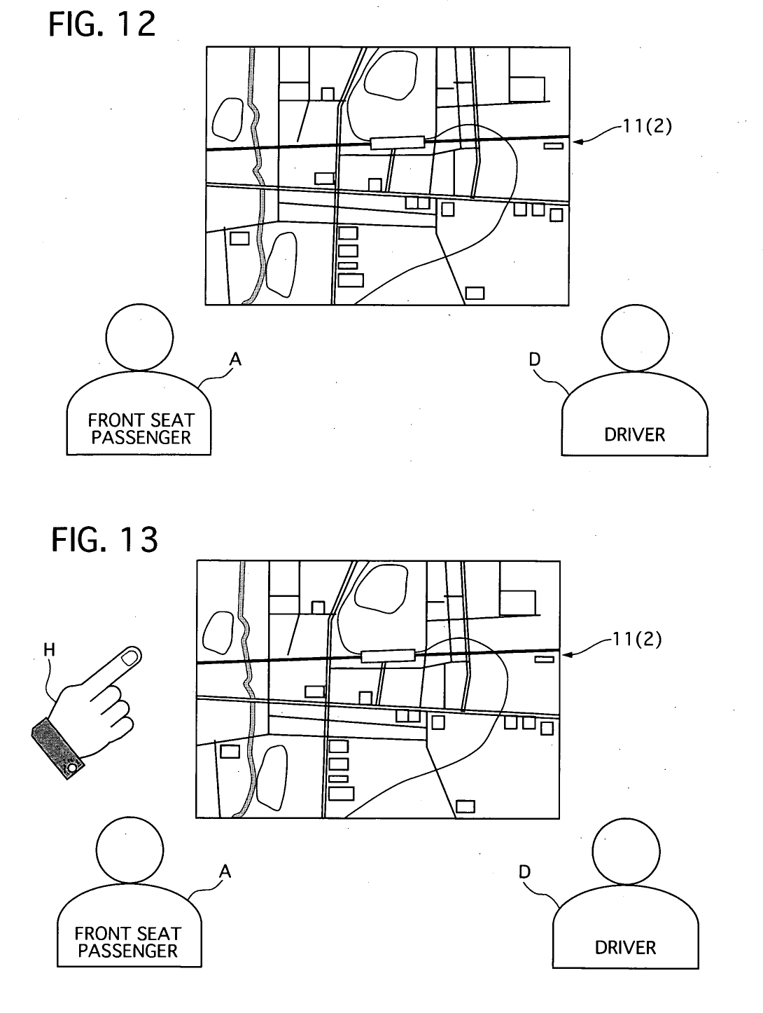

On the contrary, the device 1 of the first embodiment can remove the menu button 15 as shown as FIG. 12, thereby being capable of increasing the display area of the touch panel screen and reducing its manufacturing costs. In a state of FIG. 12, the detection sensitivity level is set higher to easily and surely detect an approaching hand H before it touches the touch panel 2 as shown in FIG. 13.

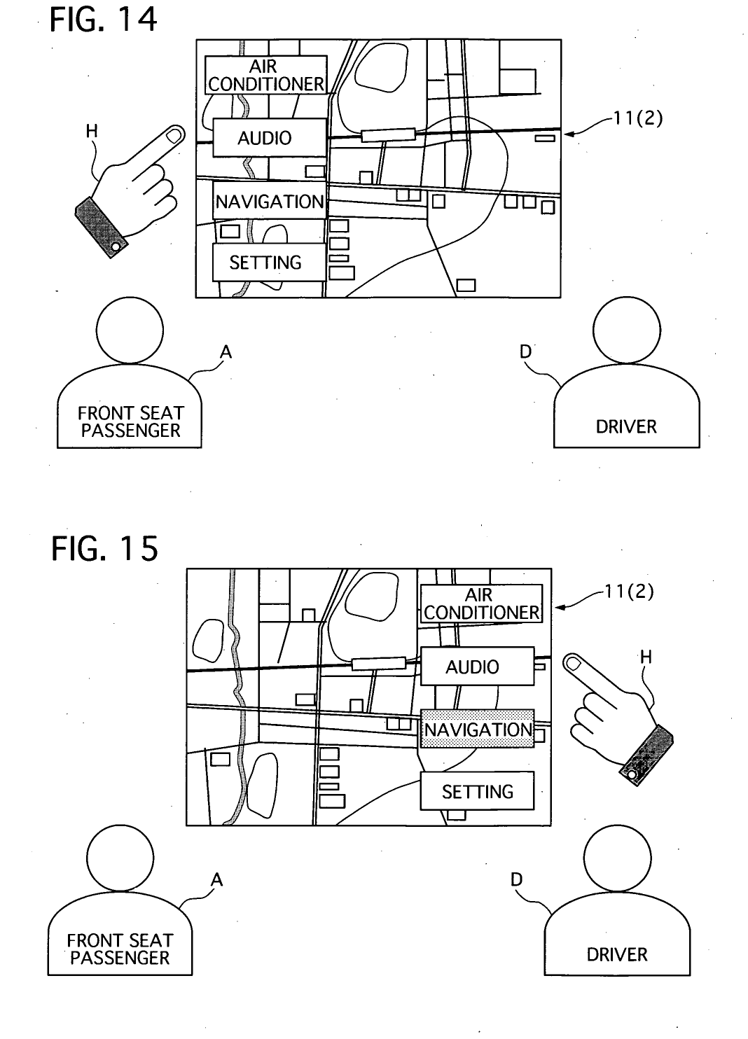

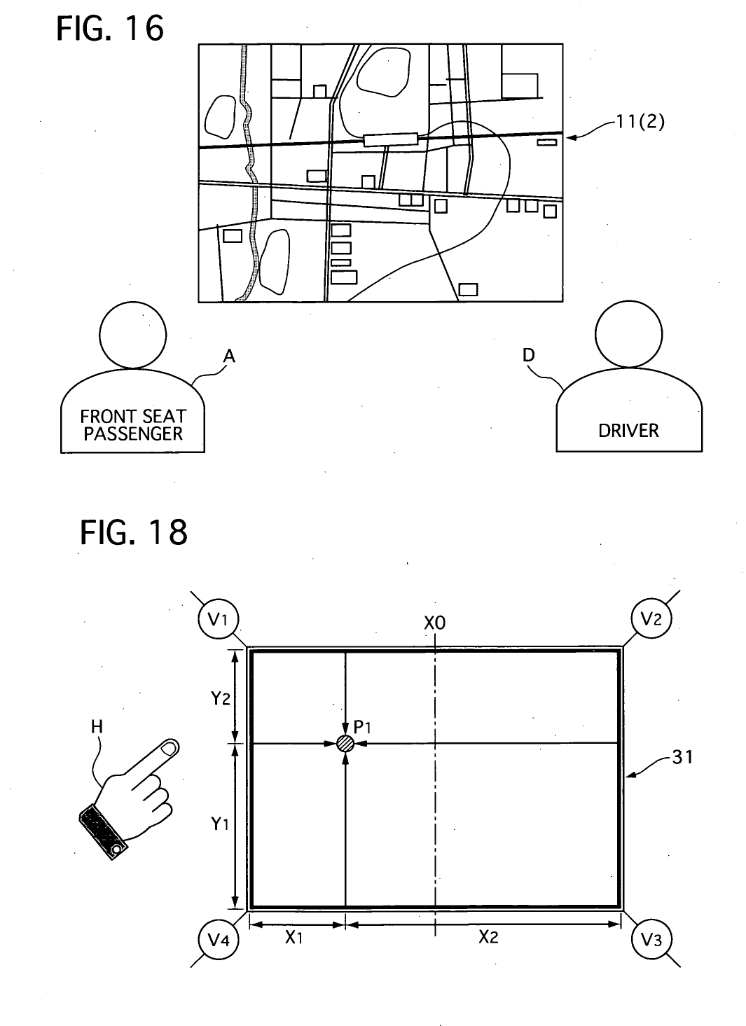

When the capacity change generated by the electrodes 3 is detected, the operator judging part 132 judges the operator to be the front seat passenger A in the case shown in FIG. 13 and then the operatable contents deciding part 133 shifts the images displayed on the touch panel screen so that the GUI icon images are arranged at the left side edge portion of the touch panel screen as shown in FIG. 14. As a result, the passenger A can easily operate the operation part 12 without hiding the navigation information image from the driver D. On the other hand, when the vehicle running state judging part 14 judges the vehicle to be stopped, it allows the driver d to operate the operation part 12. Therefore, when the hand H of the driver D approaches the touch panel 2, the operator judging part 132 judges the operator to be the driver D and then the GUI icon images are displayed at the right side edge portion of the touch panel screen as show in FIG. 15 and all of the GUI icons are in activity, namely operatable.

Incidentally, when the vehicle running state judging part 14 judges the vehicle to be running, all of the GUI icon images are displayed as shown in FIG. 15, while a GUI icon for a navigation operation becomes to be in a suspended state for the sake of safety.

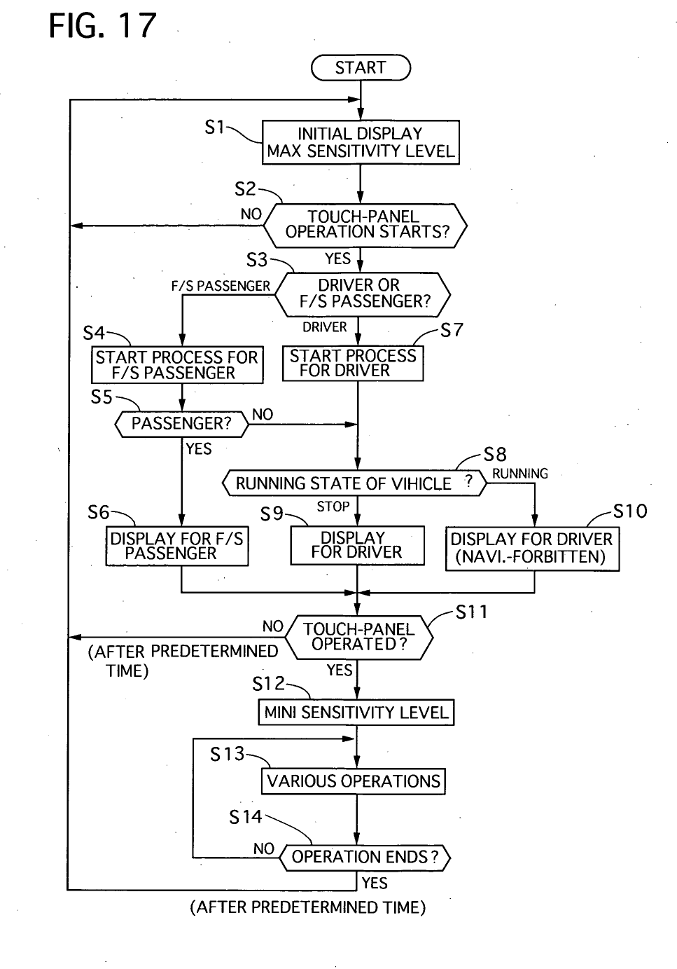

In order to obtain the above-described functions, the control device 13 executes an operator distinguishing process according to a flow chart shown in FIG. 17.

At a step S1, the control part 13 controls the display part 11 to provide an initial display and set the detection sensitivity level of the sensor part 31 of the touch panel 2 to have the maximum value, and then the flow goes to a step S2.

At the step S2, the coordinate detecting part 131 detects electrostatic capacity change values to judge whether or not an operation is going to start, and if YES, the flow goes to a step S3, while, if NO, the flow returns to the step S1.

At the step S3, the operator judging part 132 judges, based on the coordinate signals outputted from the coordinate detecting part 131, which the operator is, the driver D or the front seat passenger. If the judgment is the front seat passenger A, the flow goes to a step S4, while, if the judgment is the driver D, the flow goes to a step S7.

At the step S4, the operatable contents deciding part 133 executes a start process for the front seat passenger A, and then the flow goes to a step S5.

At the step S5, the control part 13 judges whether the front seat passenger A is on a front seat, by using a not-shown front seat sensor or the like. This step S5 is added in order to avoid undesirable operation including malicious and intentional usage and uncommon usage of the touch panel 2 by a person except the front seat passenger A. If YES, the flow goes to a step S6, while, if NO, the flow goes to a step S8.

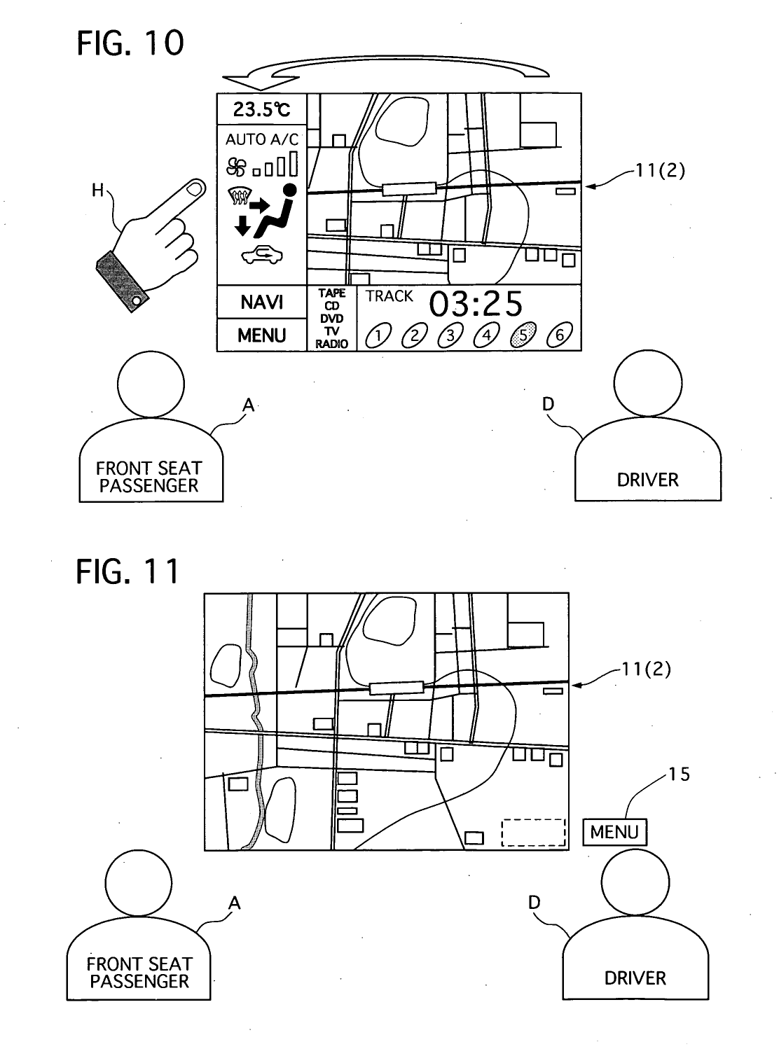

At the step S6, the operatable contents deciding part 133 controls the display part 11 to provide an image of GUIs for an operation of the front seat passenger A. For example, the GUI icon image is displayed on the left side edge portion of the touch panel screen as shown in FIGS. 8 and 10. Then, the flow goes to a step S11.

On the other hand, at the step S7, the operatable contents deciding part 133 executes a start process for the driver D, and then the flow goes to a step S8.

At the step S8, the vehicle running state judging part 14 judges whether the motor vehicle is running or stops. If the vehicle is judged to be in a running state, the flow goes to a step S10, while, if the vehicle is judged to be in a stop state, the flow goes to a step S9.

At the step S9, the operatable contents deciding part 133 controls the display part 11 to provide an image of the GUIs for an operation of the driver D. For example, the GUI icon image is displayed on the right side edge portion of the touch panel screen as shown in FIG. 15. Then, the flow goes to the step S11.

At the step S10, the operatable contents deciding part 133 controls the display part 11 to provide an image of limited GUIs for an operation of the driver D. For example, the GUI icon images displayed on the right side edge portion of the touch panel screen as shown in FIG. 15, while a GUI icon for the navigation is in a suspended state. Then, the flow goes to the step S11.

At the step S11, the coordinate detecting part 131 judges whether or not the operation part 12 is substantially touched or pressed by the finger of the operator. If YES, the flow goes to a step S12, while, if NO is kept for a first predetermined time, the flow returns to the step S1.

At the step S12, the control part 13 sets the detection sensitivity level to have the minimum level, and then the flow goes to a step S13.

At the step S13, the control part 13 allows the operator to operate the on-vehicle devices by touching the displayed activated GUI icons, and then the flow goes to a step S14.

At the step S14, the control part 13 judges whether or not the input operation of the operator ends. If YES, the flow returns to the step 1, while, if NO, the flow returns to the step S13. An end of the operation is judged when no input operation is performed for a second predetermined time.

As understood from the above description, the operator distinguishing device 1 of the first embodiment has the following advantages.

The operator distinguishing device 1 is capable of distinguishing between the two operators without using additional sensors such as infrared ray sensors, so that it can be constructed simply and at lower manufacturing costs.

The two different detection sensitivity levels of the electrodes 3 can be set so that the approaching finger F or hand H can be detected at the higher sensitivity level when the hand does not touch the touch panel 2 while the finger F can be detected at the lower sensitivity level when the finger substantially touches or presses the touch panel 2. This setting of the sensitivity levels enables the device 1 to easily detect the approaching hand and surely detect the touch point of the touch panel 2 which the finger touches. In addition, it can distinguish between the operators before he or she touches the touch panel 2, and accordingly the GUI icon images can be displayed earlier on an appropriate side portion of the touch panel screen. Therefore, the operator can easily and smoothly operate the GUI icons. Note that the detection sensitivity level may be not shifted between the different levels in the first embodiment.

The GUI icon images are moved toward the operator's side portion of the touch panel screen according to the judgment result of the operator, which enables the operator easily and surely operate them without hiding the displayed information such as the navigation for the driver D.

Next, an operator distinguishing device of a second embodiment according to the present invention will be described with reference to the accompanying drawings. The device has a structure similar to that shown in FIG. 1 of the first embodiment. The same reference numbers of parts will be used for the similar parts of the second embodiment, although they are not illustrated in figures of the second embodiment.

Referring to FIG. 18, there is shown a sensor part 31 consisting of a plurality of electrodes are provided at the rear side of a touch panel screen of the operator distinguishing device of the second embodiment similarly to those of the first embodiment, except detecting electrostatic capacity change levels.

In the second embodiment, the sensor part 31 is supplied at its four corners with regular power voltage so that a uniform electric field can be generated all over the surface of the sensor part 31. When a finger of an operator's hand H touches a portion of a touch panel 2, an electrostatic capacity change is generated at a touched position P1 so that the capacity change levels detected at the four corners as sensor electric voltages V1, V2, V3, V4 which are proportional to distances, relating to X1, X2, Y1 and Y2, between the touched position P1 and the four corners, respectively. A coordinate detecting part 131 of a control part 13 computes a coordinates (X1, Y1) of the touched position P1 based on the detected electric voltages V1 to V4.

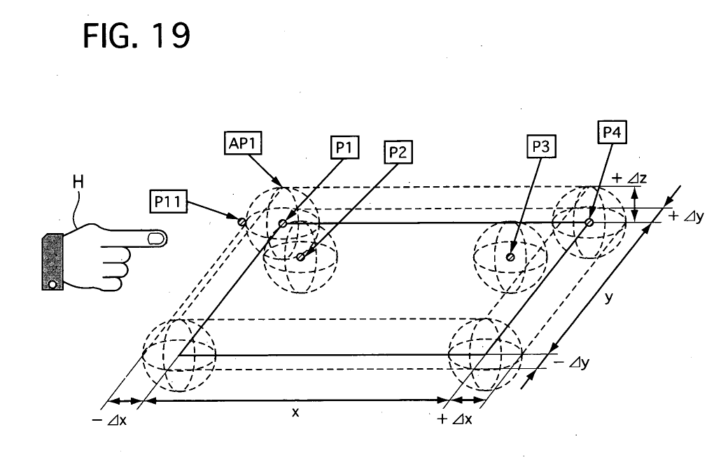

A detection sensitivity level is adjusted so as to enlarge a detectable distance, which enables the device to detect the electrostatic capacity change levels before the finger touches the surface of the touch panel 2. For example, the device detects the capacity change levels generated due to his or her approaching hand in an extended area of ±ΔX, ±ΔY and ±ΔZ as shown in FIG. 19, and an operator judging part 132 executes an operator judging process based on the outputs of the coordinate detecting part 131. In the second embodiment, in an operator distinguishing process, a detection sensitivity level is set to be higher, so that ±ΔX, ±ΔY and ±ΔZ are set to larger.

An example of the detecting process of the position of the finger is shown in FIG. 19. When a detectable area at the touched coordinates P1 is indicated by a dashed line AP1 of a sphere, the device detects the capacity change in this area to recognize it as the capacity change at the position P1. These detection and recognition are performed when the finger approaches a position P11 located in the area, before the finger touches the touch panel 2. A detectable area of each position, corresponding to the sensor part 31, is uniformly enlarged, and consequently it is enlarged all over the surface of the sensor part 31.

For example, when the finger moves from the position P1 to a position P2, the operator judging part 132 judges that the operator is a front seat passenger, because the positions P1 and P2 are located at a left side portion of the touch panel screen. On the other hand, when the finger moves from a position P4 to a position P3, the operator judging part 132 judges that the operator is a driver, because the positions P3 and P4 are located at a right side portion of the touch panel screen. Note that the movements from the Position P1 to the position P2 and from the position P4 to the position P3 are performed without the finger or hand H touching the touch panel 2.

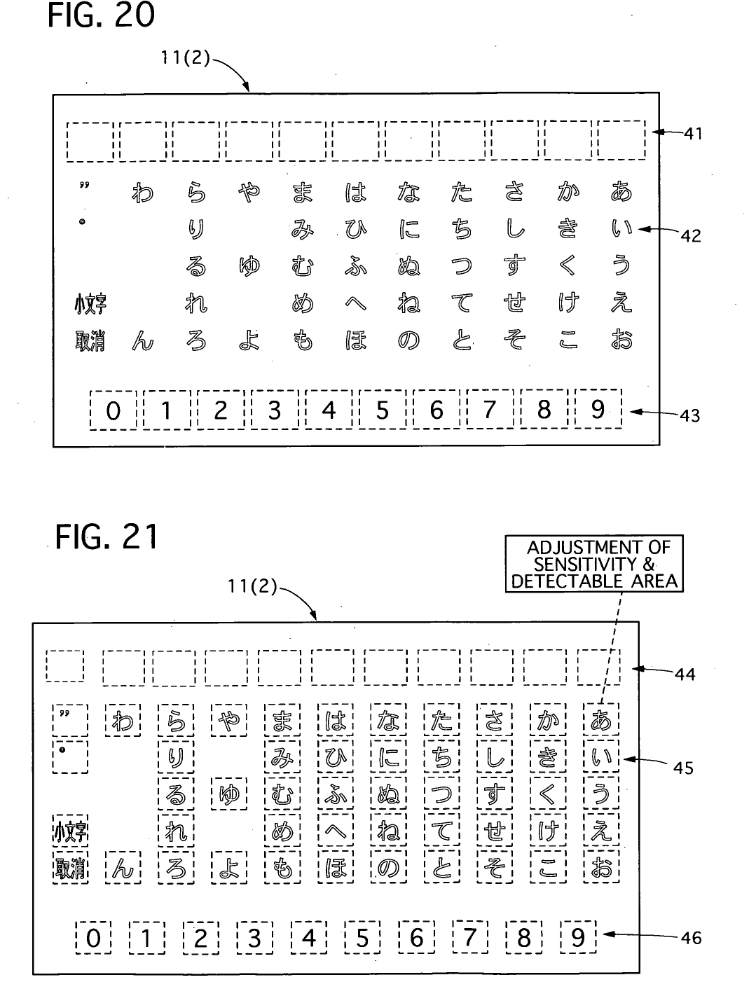

An image on the touch panel screen is shown in FIG. 19, where the detection sensitivity level is set to be higher to detect the approaching hand H before it touches the touch panel 2. A plurality of detecting areas 41 for an operation of menu icons are arranged at an upper portion of the sensor part 31, a plurality of detecting areas 42 for an operation of literal characters (Japanese letters in the second embodiment) are arranged at an intermediate portion thereof, and at a plurality of detecting areas 43 for an operation of numeric characters are arranged at a lower portion thereof. However, if the detection sensitivity level is kept to be higher, a wrong detection and wrong recognition may be occurred especially in the detecting areas 42 of the literal characters, because they are many to be close to one another. When the finger touch a position corresponding to [symbol] for example, the coordinate detecting part 131 may also recognize [symbol] [symbol] [symbol] in addition to [symbol] This wrong dictation and recognition occur in the second embodiment more than those of the first embodiment, since the coordinate detecting part 131 detects based on only the four electric volts V1 to V4. In order to avoid this problem, the detection sensitivity level is set to be lower after the finger substantially touches the touch panel 2 to decrease detectable areas 44 to 46 to be smaller as illustrated by dashed lines in FIG. 21.

The control part 13 of the second embodiment executes an input process and an operator distinguishing process according to a flow chart similar to that, shown in FIG. 17, of the first embodiment.

The other operation of the operator distinguishing device of the second embodiment is similar to that of the first embodiment.

The operator distinguishing device of the second embodiment has the following advantage in addition to the advantages of the first embodiment.

In the device, the sensor part 31 becomes simpler than that of the first embodiment. Further, in this case, even when detecting areas are arranged close to one another, like those of the literal characters, the detection and recognition of the touched position is surely performed by shifting the detection sensitivity level to be lower.

While there have been particularly shown and described with reference to preferred embodiments thereof, it will be understood that various modifications may be made therein, and it is intended to cover in the appended claims all such modifications as fall within the true spirit and scope of the invention.

The operation part 12 is not limited to the GUI icons, and it may be replaced by an appropriate operation element.

The users or operators may be rear seat passengers on a motor vehicle or the like, although they are a driver and a front seat passenger in the first and second embodiments. Further, they are not limited to passengers on a vehicle.

The entire contents of Japanese Patent Application No. 2007-032805 filed Feb. 14, 2007 are incorporated herein by reference.

What is claimed is:

1. An operator distinguishing device which distinguishing between a first operator and a second operator, comprising:
a display part for providing an image;
an operation part provided in a touch panel arranged in front of the display part, the touch panel having a plurality of electrodes for generating electrostatic capacity change when a hand of one of the first and second operators approaches the touch panel, the touch panel being arranged at a position where the touch-panel side hands of the first and second operators need to approach to the touch panel from lateral side edge portions, which are at operator-to-operate sides, of the touch panel, respectively; and
a control part detecting the electrostatic capacity change level generated by an approaching hand of the operator to distinguish the operator, who approaches the hand to the touch panel, from the other operator before the hand touches the touch panel.

2. The operator distinguishing device according to claim 1, wherein
the touch panel is arranged in front of and between the first and second operators, and is installed on an instrument panel of a motor vehicle.

3. The operator distinguishing device according to claim 2, wherein
the control part shifts detection sensitivity levels of the electrodes so that the hand the touch panel is detected at a higher detection sensitivity level before the hand touches the touch panel and the hand is detected at a lower detection sensitivity level after the hand touches the touch panel.

4. The operator distinguishing device according to claim 3, wherein
the control part controls the display part to provide the image including an information image and an GUI image on a touch panel screen so that, when the control part distinguishes the operator to operate, the GUI image is displayed at the side edge portion, which is near the operator to operate, of the touch panel screen.

5. The operator distinguishing device according to claim 1, wherein
the control part shifts detection sensitivity levels of the electrodes so that the hand the touch panel is detected at a higher detection sensitivity level before the hand touches the touch panel and the hand is detected at a lower detection sensitivity level after the hand touches the touch panel.

6. The operator distinguishing device according to claim 5, wherein
the control part controls the display part to provide the image including an information image and an GUI image on a touch panel screen so that, when the control part distinguishes the operator to operate, the GUI image is displayed at the side edge portion, which is near the operator to operate, of the touch panel screen.

7. The operator distinguishing device according to claim 1, wherein
the control part controls the display part to provide the image including an information image and an GUI image on a touch panel screen so that, when the control part distinguishes the operator to operate, the GUI image is displayed at the side edge portion, which is near the operator to operate, of the touch panel screen.
